(19) United States
(12) Patent Application Publication
(10) Pub. No.: US 2026/0036065 A1
(43) Pub. Date: Feb. 5, 2026

(54) PASSIVE THERMAL MANAGEMENT SYSTEMS AND RELATED METHODS

(71) Applicant: General Electric Company, Evendale, OH (US)

(72) Inventors: Victor Moreno Patan, Queretaro (MX); Leonardo Aguilar Willys, Queretaro (MX)

(21) Appl. No.: 19/281,169

(22) Filed: Jul. 25, 2025

Related U.S. Application Data
(60) Provisional application No. 63/678,935, filed on Aug. 2, 2024.

(51) Int. Cl. F01D 25/12

(52) U.S. Cl. CPC F01D 25/12; F01D 25/18; F01M 5/002; F02C 7/14; F02C 7/224; F05D 2260/213

(57) ABSTRACT

Systems, apparatus, articles of manufacture, and methods are disclosed for a thermal management system including a first heat exchanger with a first path and a second path to transfer thermal energy between a first fluid and a second fluid; a second heat exchanger including a third path and a fourth path to transfer thermal energy between the first fluid and a third fluid; a first thermostatic element to actuate a first thermostatic valve to control a first rate of flow of the first fluid through the first heat exchanger based on a first temperature of the first fluid; and a second thermostatic element to actuate a second thermostatic valve to control a second rate of flow of the first fluid through the second heat exchanger based on a second temperature of the third fluid.

### RELATED APPLICATION

This patent claims the benefit of U.S. Provisional Patent Application Ser. No. 63/678,935, which was filed on Aug. 2, 2024. U.S. Provisional Patent Application Ser. No. 63/678,935 is hereby incorporated herein by reference in its entirety. Priority to U.S. Provisional Patent Application Ser. No. 63/678,935 is hereby claimed.

### FIELD OF THE DISCLOSURE

This disclosure relates generally to gas turbine engines and, more particularly, to passive thermal management systems and related methods for gas turbines.

### BACKGROUND

A conventional commercial aircraft generally includes a fuselage, a pair of wings, and a propulsion system that provides thrust. The propulsion system typically includes one or more aircraft engines, such as turbofan jet engines. Traditional aircraft engines are powered by aviation turbine fuel, which is ignited with pressurized air to generate thrust. Fuel temperature plays a critical role in aircraft engine operation.

### BRIEF DESCRIPTION OF THE DRAWINGS

FIG. 1 is a schematic view of an aircraft in which examples disclosed herein can be implemented.

FIG. 2 is a schematic cross-sectional view of an example engine for an aircraft in which examples disclosed herein can be implemented.

FIG. 3A is a schematic representation of an example passive thermal management system that may be associated with the aircraft of FIG. 1 and/or the engine of FIG. 2 in accordance with the teachings of this disclosure.

FIG. 3B is a schematic representation of the passive thermal management system of FIG. 3A when the oil and fuel temperatures fall below low thresholds in accordance with the teachings of this disclosure.

FIG. 3C is a schematic representation of the passive thermal management system of FIG. 3A when the oil and fuel temperatures exceed high thresholds in accordance with the teachings of this disclosure.

FIG. 4A is a cross-sectional view of an example composite thermostatic valve that may be associated with passive thermal management systems disclosed herein in an intermediate position in accordance with the teachings of this disclosure.

FIG. 4B is a cross-sectional view of an example composite thermostatic valve that may be associated with passive thermal management systems disclosed herein in a low temperature position in accordance with the teachings of this disclosure.

FIG. 4C is a cross-sectional view of an example composite thermostatic valve that may be associated with passive thermal management systems disclosed herein in a high temperature position in accordance with the teachings of this disclosure.

FIG. 5 is a schematic representation of another, alternate example passive thermal management system that may be associated with the aircraft of FIG. 1 and/or the engine of FIG. 2 in accordance with the teachings of this disclosure.

FIG. 6 is a schematic representation of another, alternate example passive thermal management system that may be associated with the aircraft of FIG. 1 and/or the engine of FIG. 2 in accordance with the teachings of this disclosure.

FIG. 7 is a flowchart representative of an example method for passive thermal control utilizing the example thermal management systems of FIGS. 3A-C, 5, and/or 6 in accordance with the teachings of this disclosure.

In general, the same reference numbers will be used throughout the drawing(s) and accompanying written description to refer to the same or like parts. The figures are not necessarily to scale.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

An important aspect of aircraft operations is maintaining the temperature of the fuel delivered to the engine. Fuel density, volume, and weight are all affected by the temperature of the fuel. Fuel temperatures that are too low can lead to issues such as engine inefficiency, waxing, crystallization, and clogging of fuel lines. Fuel temperatures that are too high can lead to issues such as cavitation and vapor lock. As oil is routed through a gas turbine engine, it accumulates thermal energy. Conventional oil scavenge systems utilize oil coolers such as air-cooled oil coolers (“ACOCs”) and fuel-cooled oil coolers (“FCOCs”) to reduce the temperature of the oil before it is re-routed back through the engine.

In recent years, gas turbine engines have utilized thermal management systems to regulate the temperature of fuel to maximize efficiency while avoiding negative impacts of overheating of the fuel. Specifically, thermal management systems utilize heat exchangers to regulate the temperature of the fuel.

Some known thermal management systems utilize multiple heat exchangers to regulate the temperature of oil and fuel in an aircraft. Such thermal management systems utilize active control systems to control the routing of the oil to the different heat exchangers to optimize the temperature of the fuel. For example, some known thermal management systems utilize a controller in combination with a control valve to portion the amount of oil routed to the individual heat exchangers. Such systems suffer from a variety of drawbacks. For example, active control systems require inclusion of a controller, both adding weight to the aircraft and taking up additional space. Another drawback is that active control systems are prone to failure should any component of the system malfunction, whether that component is the valve itself or the controller. As such, aircrafts utilizing active control systems for thermal management of fuel require redundancies built into the system or risk the consequences of failure. When failure does occur, it can result in insufficient heating of fuel and, decreased engine efficiency.

Example passive thermal management systems and related methods are disclosed herein. Although examples disclosed herein are discussed with reference to fuel, oil, and air, any combination of fluids can be utilized (e.g., water, natural gas (e.g., methane), etc.) in place of the fuel, oil, and/or air. Examples disclosed herein utilize a plurality of heat exchangers, arranged in parallel and/or in series, for oil cooling. Examples disclosed herein control the amount of oil provided to respective ones of the plurality of heat exchangers to regulate a temperature of the fuel in the system. Example passive thermal management systems disclosed herein include a thermostatic bypass valve and a composite thermostatic valve. Further, examples disclosed herein passively route oil within an oil circuit to regulate the temperature of the fuel according to predefined thresholds for fuel temperature and oil temperature. As a result, the passive thermal management systems disclosed herein enable thermal regulation of aircraft fuel without requiring an active controller to modulate a control valve, eliminating unnecessary weight, usage of space, and maintenance required by active control systems.

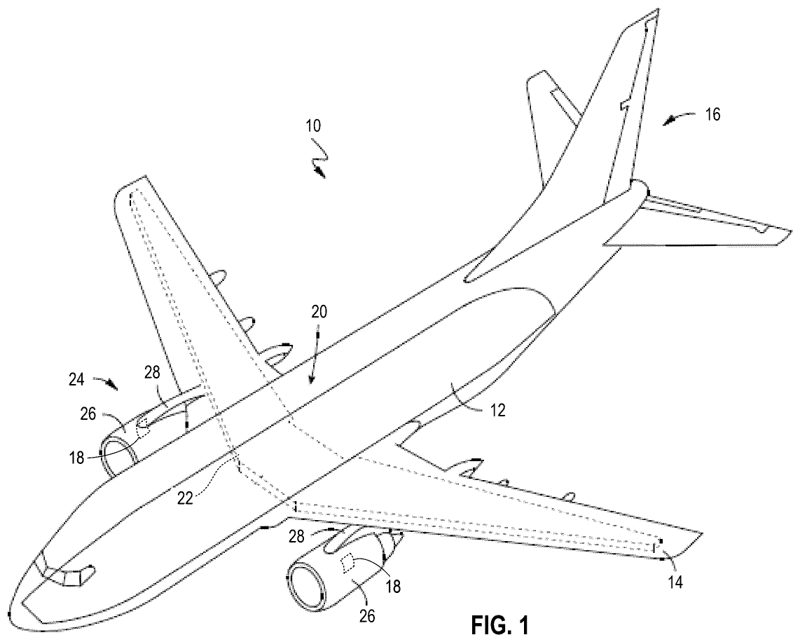

Referring now to the drawings, FIG. 1 is a perspective view of an example vehicle in which examples disclosed herein may be implemented. Specifically, for the example of FIG. 1, the vehicle is an aeronautical vehicle, or aircraft 10. The aircraft 10 includes a fuselage 12, wings 14 attached to the fuselage 12, an empennage 16, thermal management systems (“TMSs”) 18, and a fuel system 20. The TMSs 18 regulate the temperature of oil and aviation fuel. In some examples, the TMSs 18 include at least one heat exchanger, a thermostatic bypass valve, a composite thermostatic valve, an oil supply, an oil circuit, a fuel supply, and a fuel circuit. Although in the example of FIG. 1 the TMSs 18 are positioned in the aircraft engines, the TMSs 18 may be positioned at any other suitable location. The TMSs 18 may be implemented by the systems and methods disclosed herein.

The fuel system 20 includes a fuel tank 22 (e.g., a Jet-A or liquid hydrogen fuel tank, etc.) for holding fuel of the aircraft 10. In the example aircraft 10 shown in FIG. 1, at least a portion of the fuel tank 22 is located in a wing 14 of the aircraft 10. In some examples, however, the fuel tank 22 may be located at other suitable locations in the fuselage 12 or the wing 14. The fuel tank 22 may be made from known materials such as titanium, Inconel (or other suitable superalloy), aluminum, or composite materials. In other examples, the aircraft 10 may include additional and/or alternative fuel tanks 22.

The aircraft 10 further includes a propulsion system 24 that produces a propulsive thrust required to propel the aircraft 10 in flight, during taxiing operations, etc. Although the propulsion system 24 is shown attached to the wing(s) 14 in FIG. 1, in other examples it may additionally or alternatively include one or more aspects coupled to other parts of the aircraft 10, such as the empennage 16 and/or the fuselage 12.

In FIG. 1, the propulsion system 24 includes an engine, and more specifically, includes a pair of engines. More particularly, each of the engines in the pair of engines is configured as a gas turbine engine 26 (e.g., a turbo engine, etc.) mounted to one of the respective wings 14 of the aircraft 10 in an under-wing configuration through a respective pylon 28. Each gas turbine engine 26 is capable of selectively generating a propulsive thrust for the aircraft 10. The amount of propulsive thrust may be controlled at least in part based on a volume (e.g., a mass flowrate) of fuel provided to the gas turbine engines 26 via the fuel system 20.

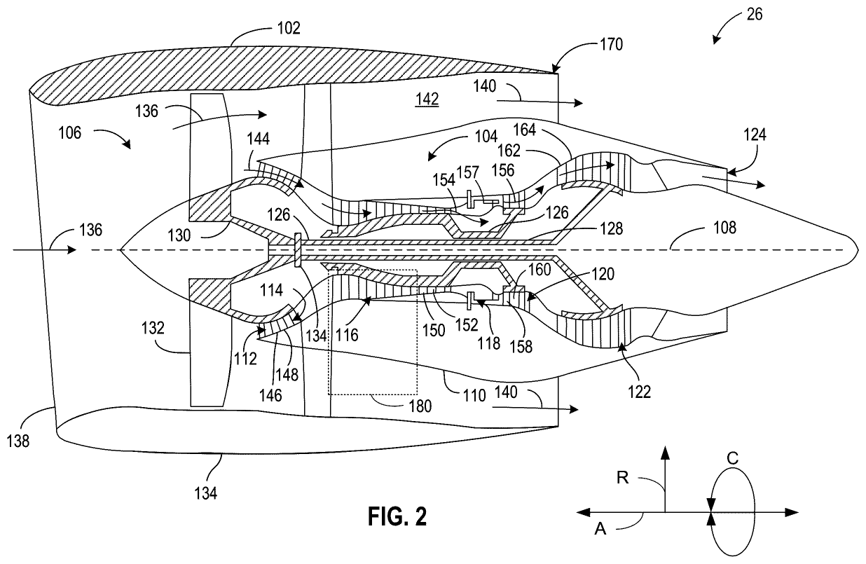

FIG. 2 is a schematic cross-sectional view of the example gas turbine engine 26 that can incorporate various examples disclosed herein. The example gas turbine engine 26 can be implemented on an aircraft and therefore referred to as an aircraft engine. In this example, the gas turbine engine 26 is a turbofan-type of engine. However, the principles of the present disclosure are also applicable to other types of engines, such as turboprop engines and engines without a nacelle, such as unducted fan (UDF) engines (sometimes referred to as propfans). Further, the examples disclosed herein can be implemented on other types of engines, such as non-aircraft engines, and/or power generators.

As shown in FIG. 2, the gas turbine engine 26 includes an outer bypass duct 102 (which may also be referred to as a nacelle, fan duct, or outer casing), a core turbine engine 104, and a fan section 106. The core turbine engine 104 and the fan section 106 are disposed at least partially in the outer bypass duct 102. The core turbine engine 104 is disposed downstream from the fan section 106 and drives the fan section 106 to produce forward thrust.

As shown in FIG. 2, the gas turbine engine 26 defines a longitudinal or axial centerline axis 108 extending therethrough for reference. FIG. 2 also includes an annotated directional diagram with reference to an axial direction A, a radial direction R, and a circumferential direction C. In general, as used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108.

The core turbine engine 104 includes a substantially tubular outer casing 110 (which may also be referred to as a mid-casing) that defines an annular inlet 112. The outer casing 110 of the core turbine engine 104 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118 (which may also be referred to as the combustor 118), a turbine section having a high pressure turbine 120 (“HP turbine 120”) and a low pressure turbine 122 (“LP turbine 122”), and an exhaust section 124.

The core turbine engine 104 includes a high pressure shaft 126 (“HP shaft 126”) that drivingly couples the HP turbine 120 and the HP compressor 116. The core turbine engine 104 also includes a low pressure shaft 128 (“LP shaft 128”) that drivingly couples the LP turbine 122 and the LP compressor 114. The LP shaft 128 also couples to a fan shaft 130.

The fan section 106 includes a plurality of fan blades 132 that are coupled to and extend radially outward from the fan shaft 130. In some examples, the LP shaft 128 may couple directly to the fan shaft 130 (i.e., a direct-drive configuration). In alternative configurations, the LP shaft 128 may couple to the fan shaft 130 via a reduction gear 134 (i.e., an indirect-drive or geared-drive configuration). While in this example the core turbine engine 104 includes two compressor and two turbines, in other examples, the core turbine engine 104 may only include one compressor and one turbine. Further, in other examples, the core turbine engine 104 can include more than two compressors and turbines. In such examples, the core turbine engine 104 may include more than two drive shafts or spools.

As illustrated in FIG. 2, during operation of the gas turbine engine 26, air 136 enters an inlet portion 138 of the gas turbine engine 26. The air 136 is accelerated by the fan blades 132. A first portion 140 of the air 136 flows into a bypass airflow passage 142, while a second portion 144 of the air 136 flows into the inlet 112 of the core turbine engine 104 (and, thus, into the LP compressor 114). Downstream of the inlet 112, one or more sequential stages of LP compressor stator vanes 146 and LP compressor rotor blades 148 coupled to the LP shaft 128 progressively compress the second portion 144 of the air 136 flowing through the LP compressor 114 en route to the HP compressor 116. Next, one or more sequential stages of HP compressor stator vanes 150 and HP compressor rotor blades 152 coupled to the HP shaft 126 further compress the second portion 144 of the air 136 flowing through the HP compressor 116. This provides compressed air 154 to the combustion section 118 where it mixes with fuel and burns to provide combustion gases 156. Fuel is injected into the combustion section 118 by one or more nozzles 157. The gas turbine engine 26 includes a fuel system to provide pressurized fuel through the nozzles 157 to the combustion section 118 of the core turbine engine 104. Example thermal management systems to control the temperature of the fuel provided to the combustion section 118 are disclosed herein.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the fan shaft 130. The combustion gases 156 then exit the core turbine engine 104 through the exhaust section 124 thereof. The combustion gases 156 mix with the first portion 140 of the air 136 from the bypass airflow passage 142. The combined gases exit an exhaust nozzle 170 (e.g., a converging/diverging nozzle) of the bypass airflow passage 142 to produce propulsive thrust.

The example TMS 18 is positioned inside the gas turbine engine 26 in a region indicated by dashed box 180. The TMS 18 is in contact with the first portion 140 of the air 136. In other examples, the TMS 18 may be positioned elsewhere (e.g., outside the gas turbine engine 26, another location within the gas turbine engine 26, etc.). In some examples, the TMS 18 is located inside a core cowl of the gas turbine engine 26. In other examples, the TMS 18 is positioned in the fan cowl of the gas turbine engine 26.

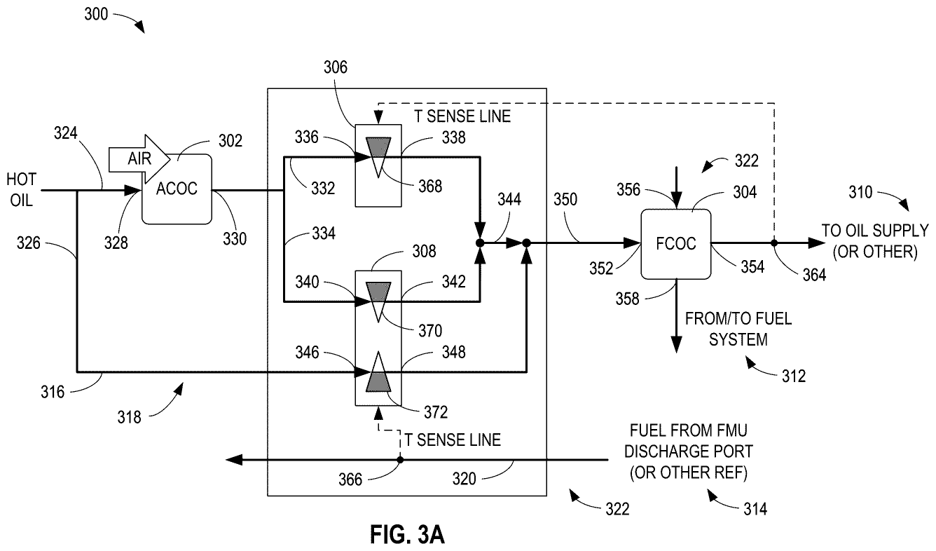

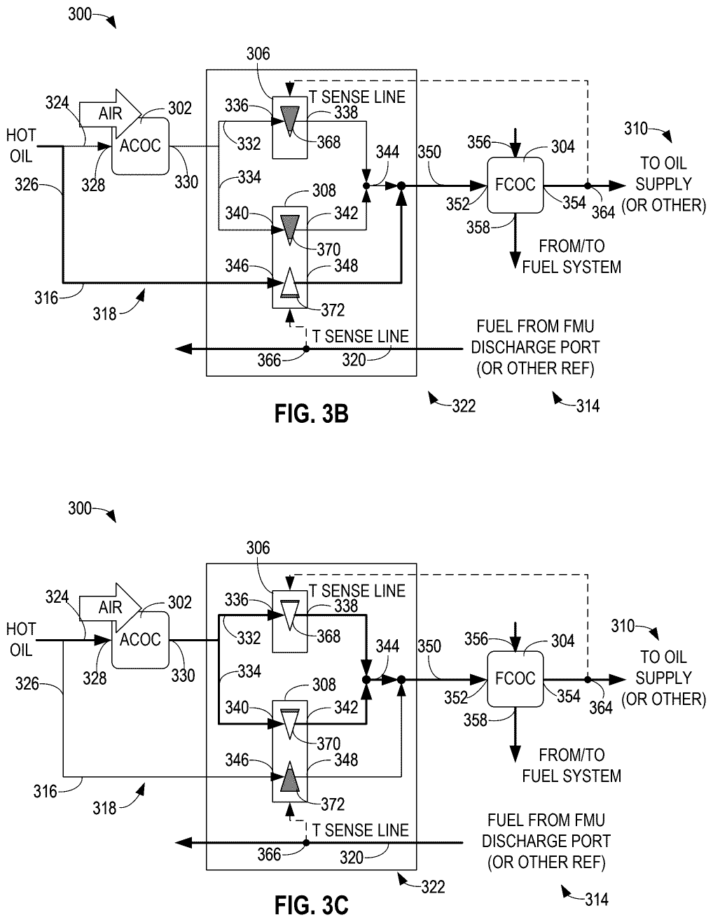

FIG. 3A is a schematic representation of an example passive TMS 300 for regulating the temperature of fuel. The passive TMS 300 includes an ACOC 302, an FCOC 304, a thermostatic bypass valve 306 (e.g., a first thermostatic valve), and a composite thermostatic valve 308 (e.g., a second thermostatic valve), an oil supply 310, a fuel supply 312, and a fuel management unit (“FMU”) 314.

The passive TMS 300 includes one or more first conduits 316 (e.g., pipes, tubes, etc.) to fluidly couple the ACOC 302, the FCOC 304, the thermostatic bypass valve 306, the composite thermostatic valve 308, and the oil supply 310. Accordingly, the first conduit(s) 316 define an oil flow circuit 318 in which the direction of the oil flow within the oil flow circuit 318 is designated by first arrowheads. The passive TMS 300 further includes one or more second conduits 320 to fluidly couple the FCOC 304, the composite thermostatic valve 308, the fuel supply 312, and the FMU 314. Accordingly, the second conduit(s) 320 define a fuel circuit 322, where the direction of the fuel flow within the oil circuit is designated by second arrowheads.

In the illustrated example of FIG. 3A, the oil enters the oil flow circuit 318 and is split into a first branch 324 of the oil flow circuit 318 and a second branch 326 of the oil flow circuit 318. The oil flowing through the first branch 324 of the oil flow circuit 318 enters the ACOC 302 through a first inlet 328 of the ACOC 302. As the oil flows through a first path in the ACOC 302 and the air flows through a second path of the ACOC 302, thermal energy is transferred from the oil to the air. In example passive TMSs utilizing fluids other than air, oil, and fuel, the ACOC 302 may instead be a different type of heat exchanger.

After flowing from a first outlet 330 of the ACOC 302, the oil is split into a third branch 332 of the oil flow circuit 318 and a fourth branch 334 of the oil flow circuit 318. The oil flowing through the third branch 332 of the oil flow circuit 318 enters the thermostatic bypass valve 306 via a second inlet 336 of the thermostatic bypass valve 306 and exits the thermostatic bypass valve 306 via a second outlet 338 of the thermostatic bypass valve 306. The oil flowing through the fourth branch 334 of the oil flow circuit 318 enters the composite thermostatic valve 308 via a third inlet 340 of the composite thermostatic valve 308 and exits the composite thermostatic valve 308 via a third outlet 342 of the composite thermostatic valve 308. The third branch 332 and the fourth branch 334 of the oil flow circuit 318 then reconnect to form a fifth branch 344. In the illustrated example of FIG. 3A, the ACOC 302 and the FCOC 304 are arranged in series with the ACOC 302 upstream of the FCOC 304. In other examples, the FCOC 304 is upstream of the ACOC 302. In other examples, the ACOC 302 and the FCOC 304 are arranged in parallel. In the examples in which the ACOC 302 and the FCOC 304 are arranged in parallel, the arrangement of the oil flow circuit 318 and the fuel circuit 322 may change based on the arrangement of the ACOC 302 and the FCOC 304. In some examples, the passive TMS 300 may include additional heat exchangers. In such examples, the additional heat exchangers may include another type of heat exchanger (e.g., an electrical heat exchanger).

The oil flowing through the second branch 326 of the oil flow circuit 318 enters the composite thermostatic valve 308 via a fourth inlet 346 of the composite thermostatic valve 308 and exits the composite thermostatic valve 308 via a fourth outlet 348 of the composite thermostatic valve 308. The second branch 326 and the fifth branch 344 then connect to form a sixth branch 350. The oil flowing through the sixth branch 350 of the oil flow circuit 318 enters the FCOC 304 through a fifth inlet 352 of the FCOC 304. As the oil flows through a third path in the FCOC 304 and the fuel flows through a fourth path in the FCOC 304, thermal energy is transferred from the oil to the fuel. After flowing from a fifth outlet 354 of the FCOC 304, the oil returns to the oil supply 310.

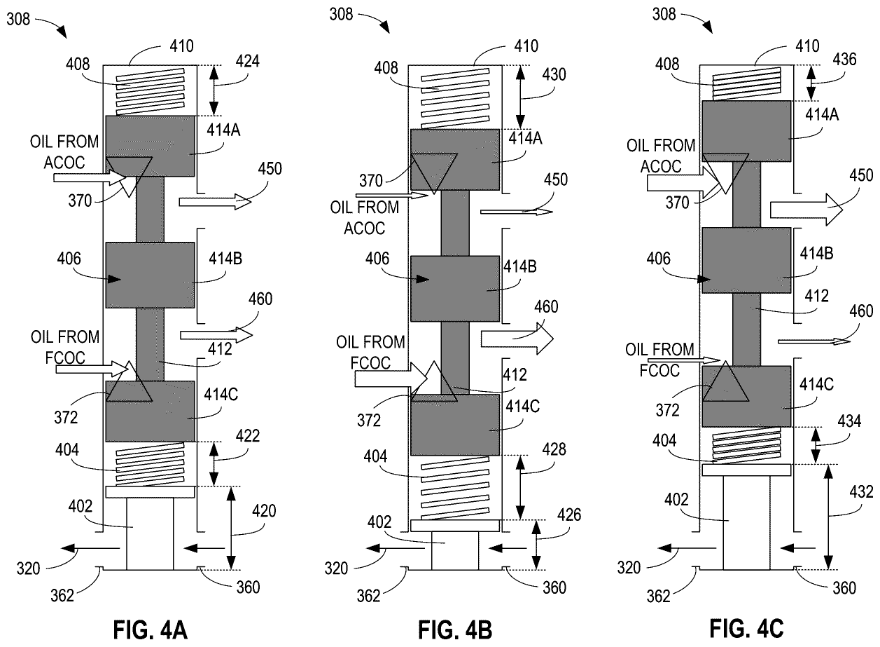

In the illustrated example of FIG. 3A, fuel enters the fourth path of the FCOC 304 through the sixth inlet 356 of the FCOC 304. The fuel receives thermal energy from the oil as the fuel flows through the FCOC 304, as described above. After flowing from the sixth outlet 358 of the FCOC 304, the fuel is provided to the FMU 314. Fuel from the FMU 314 enters the second conduit(s) 320 of the fuel circuit 322. The fuel enters the composite thermostatic valve 308 via a seventh inlet 360 (shown in FIGS. 4A-C) of the composite thermostatic valve 308 and exits the composite thermostatic valve 308 via a seventh outlet 362 (shown in FIGS. 4A-C) of the composite thermostatic valve 308. The fuel is then provided to a downstream combustion element (not shown).

In the illustrated example of FIG. 3A, the thermostatic bypass valve 306 and the composite thermostatic valve 308 are passively-controlled valves. In FIG. 3A, thermostatic bypass valve 306 is fluidly coupled to the first conduit(s) 316, the ACOC 302, the FCOC 304, and the oil supply 310. For example, the thermostatic bypass valve 306 can be positioned at the second outlet 338, at the second inlet 336, and/or between the second outlet 338 and the second inlet 336. As such, the thermostatic bypass valve 306 controls a flow rate of the oil flowing through the third branch 332 and, therefore, a flow rate of the oil flowing through the ACOC 302. The thermostatic bypass valve 306 includes a first thermostatic element coupled to a spring which is coupled to a valve body. In the passive TMS 300, the first thermostatic element is a wax pellet. In other examples, the thermostatic bypass valve 306 utilizes a shape memory alloy (“SMA”) element (e.g., copper, aluminum, steel, Nitinol, etc.) or another type of thermostatic element in addition to or instead of the wax pellet. The wax pellet is in contact with the oil at a first temperature sensing point 364 of the oil flow circuit 318. By sensing oil temperature at the first temperature sensing point 364, the wax pellet can protect against overheating and overcooling of the oil. The temperature of the oil at the first temperature sensing point 364 determines the size of the wax pellet of the thermostatic bypass valve 306. For example, higher temperatures may cause the wax pellet to expand to a larger size, changing a position of the valve body and allowing an increased rate of oil to pass through the third branch 332 of the oil flow circuit 318. Thus, the first thermostatic element actuates the thermostatic bypass valve 306 based on the temperature of the oil to control a position of the thermostatic bypass valve 306. The example first temperature sensing point 364 is located downstream of the FCOC 304 and upstream of the oil supply 310. In other examples, the first temperature sensing point 364 may be located in a different portion of the oil flow circuit 318, such as upstream of the FCOC 304.

In some examples, the type of the first thermostatic element, the size of the first thermostatic element, and/or the geometry of the first thermostatic element may be determined according to first temperature thresholds corresponding to desired oil flow splits across the ACOC 302 and the FCOC 304. For example, when the temperature of the oil at the first temperature sensing point 364 exceeds a first high temperature threshold, it may be desirable to flow more oil through the ACOC 302 to maximize available oil cooling and reduce the temperature at the oil supply 310. Likewise, when the temperature of the oil at the first temperature sensing point 364 is below a first low temperature threshold, it may be desirable to avoid cooling the oil with air at the ACOC 302 and maximize cooling with fuel at the FCOC 304, as there is less thermal energy in the oil. Therefore, the type, size, and geometry of the first thermostatic element may be selected such more or less oil is allowed to flow through the thermostatic bypass valve 306 based on the first high temperature threshold and the first low temperature threshold.

In FIG. 3A, a first fluid path of the composite thermostatic valve 308 is fluidly coupled to the first conduit(s) 316, the ACOC 302, the FCOC 304, and the oil supply 310, and a second fluid path of the composite thermostatic valve 308 is fluidly coupled to the first conduit(s) 316, the FCOC 304, and the oil supply 310. For example, the first fluid path of the composite thermostatic valve 308 is fluidly coupled between the third inlet 340 and the third outlet 342, and the second fluid path of the composite thermostatic valve 308 is fluidly coupled between the fourth inlet 346 and the fourth outlet 348. As such, the composite thermostatic valve 308 controls a flow rate of the oil flowing through second branch 326 and the fourth branch 334. In other examples, the composite thermostatic valve 308 is separated into two separate valves. A third fluid path of the composite thermostatic valve 308 is fluidly coupled to the second conduit(s) 320, the FCOC 304, the fuel supply 312, and the FMU 314. For example, the third fluid path of the composite thermostatic valve 308 is fluidly coupled between the seventh inlet 360 (shown in FIGS. 4A-C) and the seventh outlet 362 (shown in FIGS. 4A-C). The third fluid path of the composite thermostatic valve 308 includes a second thermostatic element coupled to a spring which is coupled to a valve body. In the passive TMS 300, the second thermostatic element is a wax pellet. In other examples, the composite thermostatic valve 308 utilizes a shape memory alloy (“SMA”) element or another type of thermostatic element that changes size and/or shape with a change in temperature in addition to or instead of the wax pellet. The wax pellet is in contact with the fuel at a second temperature sensing point 366 of the fuel circuit 322. By sensing the fuel temperature at the second temperature sensing point 366, the wax pellet protects against fuel overheating and overcooling, while providing preference to fuel cooling over air cooling. The temperature of the fuel at the second temperature sensing point 366 determines the size of the wax pellet of the composite thermostatic valve 308. For example, higher temperatures may cause the wax pellet to expand to a larger size, changing a position of the valve body of the composite thermostatic valve 308 and allowing an increased rate of oil to pass through the fourth branch 334 and a decreased amount of oil to pass through the second branch 326. Thus, the second thermostatic element actuates the composite thermostatic valve 308 based on the temperature of the fuel to control a position of the composite thermostatic valve 308. The example second temperature sensing point 366 is located downstream of the FCOC 304 and downstream of the FMU 314. In other examples, the second temperature sensing point 366 may be located in a different portion of the fuel circuit 322, such as upstream of the FMU 314. Advantageously, the combination of the thermostatic bypass valve 306 sensing the temperature of the oil and the composite thermostatic valve 308 sensing the temperature of the fuel allows maximization of heat transfer between the oil and the fuel while also protecting both the oil and the fuel from experiencing extreme temperatures. In some examples, the type of the second thermostatic element, the size of the first thermostatic element, and/or the geometry of the second thermostatic element may be determined according to second temperature thresholds corresponding to desired fuel temperatures. For example, when the temperature of the fuel at the second temperature sensing point 366 exceeds a second high temperature threshold, it may be desirable to increase oil flow through the ACOC 302, even if the oil temperature at the first temperature sensing point 364 does not increase air cooling, to reduce the thermal load on the FCOC 304 and allow the temperature of the fuel to decrease. Likewise, when the temperature of the fuel at the second temperature sensing point 366 is below a second low temperature threshold, it may be desirable to flow less oil through the ACOC 302, maximizing heat transfer at the FCOC 304, which will cause the temperature of the fuel to increase to a desired range. Therefore, the type, size, and geometry of the second thermostatic element may be selected such that more or less oil is allowed to flow through the composite thermostatic valve 308 based on the second high temperature threshold and the second low temperature threshold.

The exact values for the first temperature threshold values and the second temperature threshold values are specific to the particular passive TMS. For example, in a passive TMS used to regulate the temperature of fuel in an aircraft, contributing factors include the type of fuel used, a maximum temperature of the fuel before coking and/or other negative effects occur, a freezing point of the fuel, the efficiency of the engine at varying fuel temperatures, the type of oil used, a maximum temperature of the oil, a minimum temperature of the oil, fuel system and oil system component temperature capabilities, accelerated or delayed response to transients, etc. For example, the first threshold values may correspond to typical ranges for oil temperatures that fall within 150° F. and 300° F.

In the illustrated example of FIG. 3A, the thermostatic bypass valve 306 and the composite thermostatic valve 308 are located downstream of the ACOC 302 and upstream of the FCOC 304. In other examples of the passive TMS 300, at least one of the thermostatic bypass valve 306 and the composite thermostatic valve 308 may be located upstream of the ACOC 302 or downstream of the FCOC 304.

FIG. 3A illustrates the flow of oil within the passive TMS 300 when the temperature of the oil at the first temperature sensing point 364 is between the first low temperature threshold and the first high temperature threshold, and the temperature of the fuel at the second temperature sensing point 366 is between the second low temperature threshold and the second high temperature threshold. Accordingly, the thermostatic bypass valve 306 is in an intermediate position as shown by first metering window 368, and the composite thermostatic valve 308 is an intermediate position as shown by second metering window 370 and third metering window 372. The unshaded portion of the first metering window 368 corresponds to the portion of the thermostatic bypass valve 306 through which oil from the third branch 332 can flow. The unshaded portion of the second metering window 370 corresponds to the portion of the composite thermostatic valve 308 through which oil from the fourth branch 334 can flow. The unshaded portion of the third metering window 372 corresponds to the portion of the composite thermostatic valve 308 through which oil from the second branch 326 can flow.

FIG. 3B illustrates the passive TMS 300 of FIG. 3A when the temperature of the oil at the first temperature sensing point 364 is below (e.g., lower than) the first low temperature threshold, and the temperature of the fuel at the second temperature sensing point 366 is below the second low temperature threshold. As illustrated, the thermostatic bypass valve 306 closes because of the lower temperature of the oil at first temperature sensing point 264. Closing of the thermostatic bypass valve 306 reduces the flow rate of oil through the third branch 332. In some examples, the thermostatic bypass valve 306 is not fully closed to prevent oil build-up from potentially clogging the third branch 332 due to a prolonged low temperature condition. For example, the thermostatic bypass valve 306 may be in a nearly closed position when the temperature of the oil at the first temperature sensing point 364 falls below the first low temperature threshold. As used herein, a “nearly closed position” means the valve and/or flow path is less than 10% open.

In response to a decreased temperature of the fuel at second temperature sensing point 366, the composite thermostatic valve 308 modulates to close a first flow path fluidly coupled to the fourth branch 334 as illustrated by the second metering window 370 and to open a second flow path fluidly coupled to the second branch 326 as illustrated by the third metering window 372. The closing of the first flow path and opening of the second flow path causes a decrease in the flow rate of oil through the fourth branch 334 and an increase in the flow rate of oil through the second branch 326. In some examples, the first flow path is not fully closed to prevent oil build-up from potentially clogging the fourth branch 334 due to a prolonged low temperature condition. For example, the first flow path may be in a nearly closed position when the temperature of the fuel at the second temperature sensing point 366 falls below the second low temperature threshold.

The combination of the closing the thermostatic bypass valve 306, closing the first flow path of the composite thermostatic valve 308, and opening the second flow path of the composite thermostatic valve 308 causes a decrease in the flow rate of oil routed through the first branch 324 and therefore the ACOC 302, and causes an increase in the flow rate of oil routed through the second branch 326 and, therefore, increasing the amount of oil that is delivered to the FCOC 304 without first passing through the ACOC 302. The increase in the amount of oil delivered to the FCOC without first passing through the ACOC 302 increases the amount of heat exchanged between the oil and the fuel.

FIG. 3C illustrates the passive TMS 300 of FIG. 3A when the temperature of the oil at the first temperature sensing point 364 is above (e.g., higher than) the first high temperature threshold, and the temperature of the fuel at the second temperature sensing point 366 is above the second high temperature threshold. As illustrated, the thermostatic bypass valve 306 opens because of the higher temperature of the oil at first temperature sensing point 364. The opening of the thermostatic bypass valve 306 increases the flow rate of oil through the third branch 332. In some examples, the second high temperature threshold corresponds to a maximum temperature of the fuel (e.g., 200 degrees Fahrenheit, 300 degrees Fahrenheit, etc.). In such examples, the second high temperature threshold advantageously enables the composite thermostatic valve 308 to passively prevent overheating of the fuel without the need for controller circuitry.

In response to an increased temperature of the fuel at the second temperature sensing point 366, the composite thermostatic valve 308 modulates to open the first flow path as illustrated by the second metering window 370 and to close the second flow path as illustrated by the third metering window 372. This modulation of the composite thermostatic valve 308 causes an increase in the flow rate of oil through the fourth branch 334 and a decrease in the flow rate of oil through the second branch 326. In some examples, the second flow path is not fully closed to prevent oil build-up from potentially clogging the second branch 326 due to a prolonged high temperature condition. For example, the second flow path may be in a nearly closed position when the temperature of the fuel at the second temperature sensing point 366 exceeds the second high temperature threshold.

The combination of the opening the thermostatic bypass valve 306, opening the first flow path of the composite thermostatic valve 308, and closing the second flow path of the composite thermostatic valve 308 causes an increase in the flow rate of oil routed through the first branch 324 and therefore the ACOC 302, and causes a decrease in the flow rate of oil routed through the second branch 326 and therefore decreasing the amount of oil that is delivered to the FCOC 304 without first passing through the ACOC 302. The decreasing of the amount of oil delivered to the FCOC 304 without first passing through the ACOC 302 reduces the amount of heat transferred to the fuel, causing the temperature of the fuel to decrease.

FIG. 4A is a cross-sectional view of the example composite thermostatic valve 308. The example composite thermostatic valve 308 includes a thermostatic element 402, a first spring 404, a valve body 406, a second spring 408, and a housing 410. The thermostatic element 402 is a wax pellet. In other examples, the composite thermostatic valve 308 utilizes an SMA element or another type of thermostatic element in addition to or instead of the wax pellet. The example valve body 406 includes a stem 412 and a plurality of spools 414. In the illustrated example of FIGS. 4A-4C, the valve body 406 includes a first spool 414A, a second spool 414B, and a third spool 414C. In other examples, the valve body 406 may include fewer (e.g., two) or more (e.g., four, five, etc.) spools 414. The housing 410 includes the third inlet 340 and the third outlet 342 to provide a first oil path 450 through the composite thermostatic valve 308, the fourth inlet 346 and the fourth outlet 348 to provide a second oil path 460 through the composite thermostatic valve 308, and the seventh inlet 360 and the seventh outlet 362 to provide a fuel path through the composite thermostatic valve 308. In other examples, the housing 410 may include fewer or more inlets and/or outlets. In other examples, the housing 410 provides fewer or more distinct flow paths for oil through the composite thermostatic valve 308.

Fuel enters the composite thermostatic valve 308 at the seventh inlet 360 and contacts the thermostatic element 402. The thermostatic element 402 reacts to changes in temperature by expanding or contracting in response to a temperature increase or decrease. The thermostatic element 402 is coupled to the first spring 404 and the second spring 408. When the size of the thermostatic element 402 changes, the first spring 404 and the second spring 408 compress or decompress. Thus, the thermostatic element 402 actuates the composite thermostatic valve 308 based on the temperature of the fuel. FIG. 4A illustrates the composite thermostatic valve 308 when the temperature of the fuel in contact with the thermostatic element 402 is at a first temperature between a low fuel temperature threshold and a high fuel temperature threshold. The thermostatic element 402 has a first height 420 when the fuel is at the first temperature. The thermostatic element 402 pushes against the first spring 404, the valve body 406, and the second spring 408. When the thermostatic element 402 has the first height 420, the first spring has a first length 422 and the second spring has a second length 424. Accordingly, the valve body 406 is put in an intermediate position by the thermostatic element 402 and the first and second springs 404, 408. More specifically, the valve body 406 is positioned such that the first spool 414A covers approximately half of the third inlet 340 and the third spool 414C covers approximately half of the fourth inlet 346. This position of the valve body 406 is illustrated in FIG. 4A by the second and third fuel metering windows 370, 372. The amount of the third inlet 340 and fourth inlet 346 covered by the valve body 406 is determined by the height of the thermostatic element 402 at the given temperature. In the intermediate position, the valve body 406 and the composite thermostatic valve 308 generally allow oil to flow through both of the first and the second oil path 450, 460 at an intermediate rate of flow.

FIG. 4B illustrates the composite thermostatic valve 308 when the temperature of the fuel in contact with the thermostatic element 402 is at a second temperature lower than the low fuel temperature threshold. In response to the lower temperature, the thermostatic element 402 contracts to a second height 426 less than the first height 420. As a result, the first spring 404 decompresses to a third length 428 and the second spring 408 decompresses to a fourth length 430. Accordingly, the valve body 406 is put in a low temperature position by the thermostatic element 402 and the first and second springs 404, 408. More specifically, the valve body 406 is positioned such that the first spool 414A covers nearly the entire third inlet 340 and the fourth inlet 346 is mostly unobstructed by the third spool 414C. This position of the valve body 406 is illustrated in FIG. 4B by the second and third metering windows 370, 372. In the in the low temperature position, the valve body 406 and the composite thermostatic valve 308 generally allow oil to flow through the second oil path 460 at a higher rate of flow than the oil flowing through the first oil path 450. The higher rate of oil flow through the second oil path 460 than the first oil path 450 causes more of the thermal energy from the oil to be transferred to the fuel via the FCOC 304 raising the temperature of the fuel.

FIG. 4C illustrates the composite thermostatic valve 308 when the temperature of the fuel in contact with the thermostatic element 402 is at a third temperature higher than the high fuel temperature threshold. In response to the higher temperature, the thermostatic element 402 expands to a third height 432 taller than the first height 420. As a result, the first spring compresses to a fifth length 434 and the second spring 408 compresses to a sixth length 436. Accordingly, the valve body 406 is put in a high temperature position by the thermostatic element 402 and the first and second springs 404, 408. More specifically, the valve body 406 is positioned such that the third inlet 340 is mostly unobstructed by the first spool 414A and the third spool 414C covers nearly the entire fourth inlet 346. This position of the valve body 406 is illustrated in FIG. 4C by the second and third metering windows 370, 372. In the in the high temperature position, the valve body 406 and the composite thermostatic valve 308 generally allow oil to flow through the first oil path 450 at a higher rate of flow than the oil flowing through the second oil path 460. The higher rate of oil flow through the first oil path 450 than the second oil path 460 causes more of the thermal energy from the oil to be transferred to air via the ACOC 302 allowing the temperature of the fuel to decrease.

In some examples, the composite thermostatic valve 308 is designed such that neither of the first and second oil paths 450, 460 can be fully closed. For example, the composite thermostatic valve 308 may be designed such that the thermostatic element 402 can modulate between a minimum height at extremely cold temperatures and a maximum height at extremely high temperatures. In these examples, the valve body 406 is configured to leave at least a portion of the third inlet 340 and the fourth inlet 346 unobstructed when the thermostatic element is at the minimum height and the maximum height.

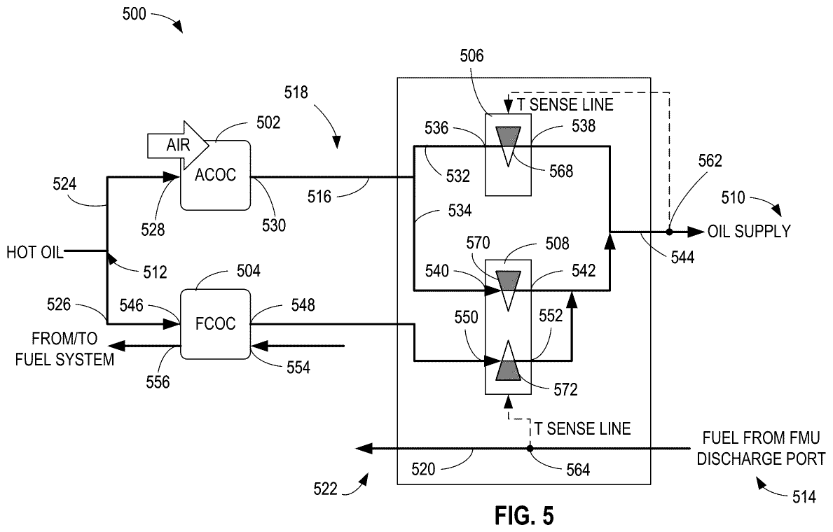

FIG. 5 is a schematic representation of another, alternate example passive thermal management system 500. The passive TMS 500 includes an ACOC 502, an FCOC 504, a thermostatic bypass valve 506, and a composite thermostatic valve 508, an oil supply 510, a fuel supply 512, and a fuel management unit (“FMU”) 514. In the passive TMS 500, the ACOC 502 and the FCOC 504 are arranged in parallel. By arranging the ACOC 502 and FCOC 504 in parallel, hot oil can be routed directly to both the ACOC 502 and the FCOC 504 without having first passed through the other of the ACOC 502 and the FCOC 504. Routing hot oil directly to each of the ACOC 502 and the FCOC 504, the passive TMS 500 is able to maximize the temperature differential between the oil and the cooling fluid, leading to a higher rate of heat transfer.

The passive TMS 500 includes one or more first conduits 516 (e.g., pipes, tubes, etc.) to fluidly couple the ACOC 502, the FCOC 504, the thermostatic bypass valve 506, the composite thermostatic valve 508, and the oil supply 510. Accordingly, the first conduit(s) 516 define an oil flow circuit 518 where the direction of the oil flow within the oil flow circuit 518 is designated by an arrow. The passive TMS 500 further includes one or more second conduits 520 to fluidly couple the FCOC 504, the composite thermostatic valve 508, the fuel supply 512, and the FMU 514. Accordingly, the second conduit(s) 520 define a fuel circuit 522, where the direction of the fuel flow is designated by an arrow.

In the illustrated example of FIG. 5, the oil enters the oil flow circuit 518 and is split into a first branch 524 of the oil flow circuit 518 and a second branch 526 of the oil flow circuit 518. The oil flowing through the first branch 524 of the oil flow circuit 518 enters the ACOC 502 through a first inlet 528 of the ACOC 502. In example passive TMSs utilizing fluids other than air, oil, and fuel, the ACOC 502 may instead be a different type of heat exchanger. After flowing from a first outlet 530 of the ACOC 502, the oil is split into a third branch 532 of the oil flow circuit 518 and a fourth branch 534 of the oil flow circuit 518. The oil flowing through the third branch 532 of the oil flow circuit 518 enters the thermostatic bypass valve 506 via a second inlet 536 of the thermostatic bypass valve 506 and exits the thermostatic bypass valve 506 via a second outlet 538 of the thermostatic bypass valve 506. The oil flowing through the fourth branch 534 of the oil flow circuit 518 enters the composite thermostatic valve 508 via a third inlet 540 of the composite thermostatic valve 508 and exits the composite thermostatic valve 508 via a third outlet 542 of the composite thermostatic valve 508. The third branch 532 and the fourth branch 534 of the oil flow circuit 518 then reconnect to form a fifth branch 544.

The oil flowing through the second branch 526 of the oil flow circuit 518 enters the FCOC 504 through a fourth inlet 546 of the FCOC 504 and exits the FCOC 504 via a fourth outlet 548 of the FCOC 504. The oil enters the composite thermostatic valve 508 via a fifth inlet 550 of the composite thermostatic valve 508 and exits the composite thermostatic valve 508 via a fifth outlet 552 of the composite thermostatic valve 508. The second branch 526 and the fourth branch 534 merge into the fifth branch 544. The oil flowing through the fifth branch 544 returns to the oil supply 510.

In the illustrated example of FIG. 5, fuel enters the FCOC 504 through a sixth inlet 554 of the FCOC 504. The fuel receives thermal energy from the oil as the fuel flows through the FCOC 504, as described above. After flowing from a sixth outlet 556 of the FCOC 504, fuel is routed to the FMU 514. From the FMU 514, the fuel enters the second conduit(s) 520 of the fuel circuit 522. The fuel enters the composite thermostatic valve 508 via a seventh inlet 558 (not shown) of the composite thermostatic valve 508 and exits the composite thermostatic valve 508 via a seventh outlet 560 (not shown) of the composite thermostatic valve 508. The fuel is then provided to a downstream combustion element (not shown).

In FIG. 5, thermostatic bypass valve 506 is fluidly coupled to the first conduit(s) 516, the ACOC 502, the FCOC 504, and the oil supply 510. For example, the thermostatic bypass valve 506 can be positioned at the second outlet 538, at the second inlet 536, and/or between the second outlet 538 and the second inlet 536. As such, the thermostatic bypass valve 506 controls a flow rate of the oil flowing through the third branch 532 and therefore a flow rate of the oil flowing through the ACOC 502. The thermostatic bypass valve 506 is in contact with the oil at a first temperature sensing point 562 of the oil flow circuit 518. The temperature of the oil at the first temperature sensing point 562 determines the position of a valve body of the thermostatic bypass valve 506. For example, higher temperatures may cause the valve body to change positions, allowing an increased rate of oil to pass through the third branch 532 of the oil flow circuit 518. The example first temperature sensing point 562 is located downstream of the FCOC 504 and upstream of the oil supply 510. In other examples, the first temperature sensing point 562 may be located in a different portion of the oil flow circuit 518, such as upstream of the FCOC 504.

In FIG. 5, a first fluid path of the composite thermostatic valve 508 is fluidly coupled to the first conduit(s) 516, the ACOC 502, the oil supply 510, and a second fluid path of the composite thermostatic valve 508 is fluidly coupled to the first conduit(s) 516, the FCOC 504, and the oil supply 510. For example, the first fluid path of the composite thermostatic valve 508 is fluidly coupled between the third inlet 540 and the third outlet 542, and the second fluid path of the composite thermostatic valve 508 is fluidly coupled between the fifth inlet 550 and the fifth outlet 552. As such, the composite thermostatic valve 508 controls a flow rate of the oil flowing through second branch 526 and the fourth branch 534. A third fluid path of the composite thermostatic valve 508 is fluidly coupled to the second conduit(s) 520, the FCOC 504, the fuel supply 512, and the FMU 514. For example, the third fluid path of the composite thermostatic valve 508 is fluidly coupled between the seventh inlet 558 (not shown in FIG. 5) and the seventh outlet 560 (not shown in FIG. 5). The composite thermostatic valve 508 is in contact with the fuel at a second temperature sensing point 564 of the fuel circuit 522. The temperature of the fuel at the second temperature sensing point 564 determines the position of a valve body of the composite thermostatic valve 508. For example, higher temperatures may cause the valve body to change positions, allowing an increased rate of oil to pass through the fourth branch 534 and a decreased amount of oil to pass through the second branch 526. The example second temperature sensing point 564 is located downstream of the FCOC 504 and downstream of the FMU 514. In other examples, the second temperature sensing point 564 may be located in a different portion of the fuel circuit 522, such as upstream of the FMU 514.

In the illustrated example of FIG. 5, the thermostatic bypass valve 506 and the composite thermostatic valve 508 are located downstream of the ACOC 502 and the FCOC 504. In other examples of the passive TMS 500, at least one of the thermostatic bypass valve 506 and the composite thermostatic valve 508 may be located upstream of the ACOC 502 and the FCOC 504.

FIG. 5 illustrates the flow of oil in the passive TMS 500 when the temperature of the oil at the first temperature sensing point 562 is between a first low temperature threshold and a first high temperature threshold, and the temperature of the fuel at the second temperature sensing point 564 is between a second low temperature threshold and a second high temperature threshold. Accordingly, the thermostatic bypass valve 506 is in an intermediate position as shown by first metering window 568, and the composite thermostatic valve 508 is an intermediate position as shown by second metering window 570 and third metering window 572.

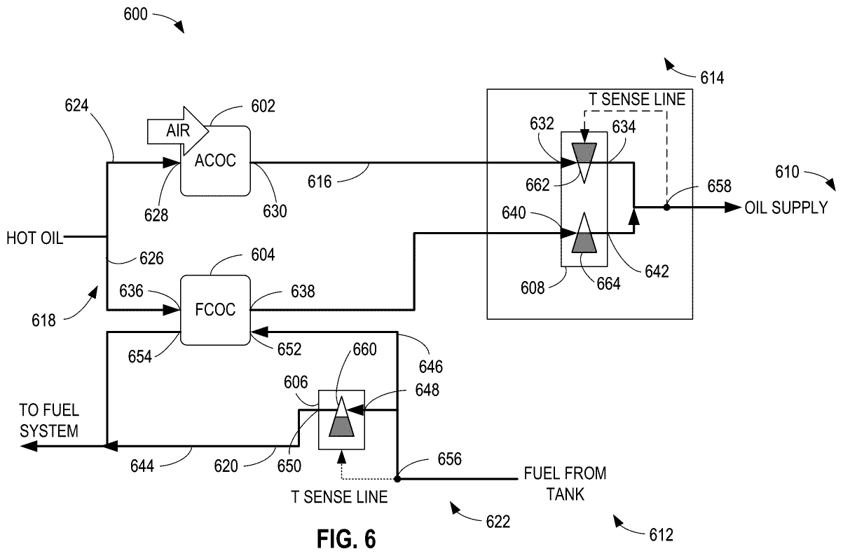

FIG. 6 is a schematic representation of another alternate example passive thermal management system 600. The passive TMS 600 includes an ACOC 602, an FCOC 604, a thermostatic bypass valve 606, a composite thermostatic valve 608, an oil supply 610, a fuel supply 612, and a fuel system 614. In the passive TMS 600, the ACOC 602 and the FCOC 604 are in parallel and the thermostatic bypass valve 606 is positioned in the fuel circuit while the composite thermostatic valve is positioned in the oil circuit. By positioning the heat exchangers 602, 604 and the valves 606, 608 in this manner, the passive TMS 600 does not require a complicated arrangement of conduits while achieving a wider range of thermal energy transfer between the oil and the fuel. For example, when the fuel is routed through the FCOC 604 at a high rate, and the oil is routed through the FCOC 604 at a rate, the amount of thermal energy transfer is at its highest. On the other hand, when the fuel is routed mainly through the thermostatic bypass valve 606 and the oil is routed primarily through the ACOC 602, a minimum amount of heat transfer occurs between the oil and the fuel.

The passive TMS 600 includes one or more first conduits 616 (e.g., pipes, tubes, etc.) to fluidly couple the ACOC 602, the FCOC 604, the composite thermostatic valve 608, and the oil supply 610. Accordingly, the first conduit(s) 616 define an oil flow circuit 618 where the direction of the oil flow within the oil flow circuit 618 is designated by an arrow. The passive TMS 600 further includes one or more second conduits 620 to fluidly couple the FCOC 604, the thermostatic bypass valve 606, the fuel supply 612, and the fuel system 614. Accordingly, the second conduit(s) 620 define a fuel circuit 622, where the direction of the fuel flow is designated by an arrow.

In the illustrated example of FIG. 6, the oil enters the oil flow circuit 618 and is split into a first branch 624 of the oil flow circuit 618 and a second branch 626 of the oil flow circuit 618. The oil flowing through the first branch 624 of the oil flow circuit 618 enters the ACOC 602 through a first inlet 628 of the ACOC 602. In example passive TMSs utilizing fluids other than air, oil, and fuel, the ACOC 602 may instead be a different type of heat exchanger. After flowing from a first outlet 630 of the ACOC 602, the oil enters the composite thermostatic valve 608 via a second inlet 632 of the composite thermostatic valve 608 and exits the composite thermostatic valve 608 via a second outlet 634 of the thermostatic bypass valve 606. The oil flowing through the second branch 626 of the oil flow circuit 618 enters the FCOC 604 through a third inlet 636 of the FCOC 604 and exits the FCOC 604 via a third outlet 638 of the FCOC 604. The oil enters the composite thermostatic valve 608 via a fourth inlet 640 of the composite thermostatic valve 608 and exits the composite thermostatic valve 608 via a fourth outlet 642 of the composite thermostatic valve 608. The second branch 626 then merges into the first branch 624 and the oil flow circuit 618 returns to the oil supply 610.

In the illustrated example of FIG. 6, fuel from the fuel supply 612 enters the second conduit(s) 620 of the fuel circuit 622. The fuel is split into a third branch 644 of the fuel circuit 622 and a fourth branch 646 of the fuel circuit 622. The fuel flowing through the third branch 644 enters the thermostatic bypass valve 606 through a fifth inlet 648 of the thermostatic bypass valve 606 and exits the thermostatic bypass valve 606 via a fifth outlet 650. The fuel flowing through the fourth branch 646 enters the FCOC 604 through a sixth inlet 652 of the FCOC 604 and exits the FCOC 604 via a sixth outlet 654. The third branch 644 and the fourth branch 646 merge, and the fuel continues into the fuel system 614.

In FIG. 6, thermostatic bypass valve 606 is fluidly coupled to the second conduit(s) 620, the FCOC 604, the fuel supply 612, and the fuel system 614. For example, the thermostatic bypass valve 606 can be positioned at the fifth outlet 650, at the fifth inlet 648, and/or between the fifth outlet 650 and the fifth inlet 648. As such, the thermostatic bypass valve 606 controls a flow rate of the fuel flowing through the third branch 644 and, therefore, a flow rate of the fuel flowing through the fourth branch 646 and the FCOC 604. The thermostatic bypass valve 606 is in contact with the fuel at a first temperature sensing point 656 of the fuel circuit 622. The temperature of the fuel at the first temperature sensing point 656 determines the position of a valve body of the thermostatic bypass valve 606. For example, higher temperatures may cause the valve body to change positions, and allow an increased rate of fuel to pass through the third branch 644 of the fuel circuit 622. The example first temperature sensing point 656 is located near the fuel supply 612. In other examples, the first temperature sensing point 656 may be located in a different portion of the fuel circuit 622.

In FIG. 6, a first fluid path of the composite thermostatic valve 608 is fluidly coupled to the first conduit(s) 616, the ACOC 602, the oil supply 610, and a second fluid path of the composite thermostatic valve 608 is fluidly coupled to the first conduit(s) 616, the ACOC 602, the FCOC 604, and the oil supply 610. For example, the first fluid path of the composite thermostatic valve 608 is fluidly coupled between second inlet 632 and the second outlet 634, and the second fluid path of the composite thermostatic valve 608 is fluidly coupled between the fourth inlet 640 and the fourth outlet 642. As such, the composite thermostatic valve 608 controls a flow rate of the oil flowing through first branch 624 and the second branch 626. A third fluid path of the composite thermostatic valve 608 is fluidly coupled to the first conduit(s) 616, the ACOC 602, the FCOC 604, and the oil supply 610. The composite thermostatic valve 608 is in contact with the oil at a second temperature sensing point 658 of the oil flow circuit 618. The temperature of the oil at the second temperature sensing point 658 determines the position of a valve body of the composite thermostatic valve 608. For example, higher temperatures may cause the valve body to change positions, allowing an increased rate of oil to pass through the first branch 624 of the oil flow circuit 618. The example second temperature sensing point 658 is located downstream of the ACOC 602 and the FCOC 604. In other examples, the second temperature sensing point 658 may be located in a different portion of the oil flow circuit 618, such as upstream of the ACOC 602 and the FCOC 604.

FIG. 6 illustrates the oil flow in the passive TMS 600 when the temperature of the fuel at the first temperature sensing point 656 is between a first low temperature threshold and a first high temperature threshold, and the temperature of the oil at the second temperature sensing point 658 is between a second low temperature threshold and a second high temperature threshold. Accordingly, the thermostatic bypass valve 606 is in an intermediate position as shown by first metering window 660, and the composite thermostatic valve 608 is an intermediate position as shown by second metering window 662 and third metering window 664.

In some examples, the passive TMSs 300, 500, 600 of FIGS. 3A-6 include means for exchanging thermal energy between two fluids. For example, the means for exchanging may be implemented by the ACOC 302, 502, 602 or the FCOC 304, 504, 604.

In some examples, the passive TMSs 300, 500, 600 of FIGS. 3A-6 include means for passively controlling the flow of oil based on the temperature of the oil. For example, the means for controlling may be implemented by the thermostatic bypass valve 306, 506, 606.

In some examples, the passive TMSs 300, 500, 600 of FIGS. 3A-6 include means for passively controlling the flow of oil based on the temperature of fuel. For example, the means for controlling may be implemented by the composite thermostatic valve 308, 508, 608.

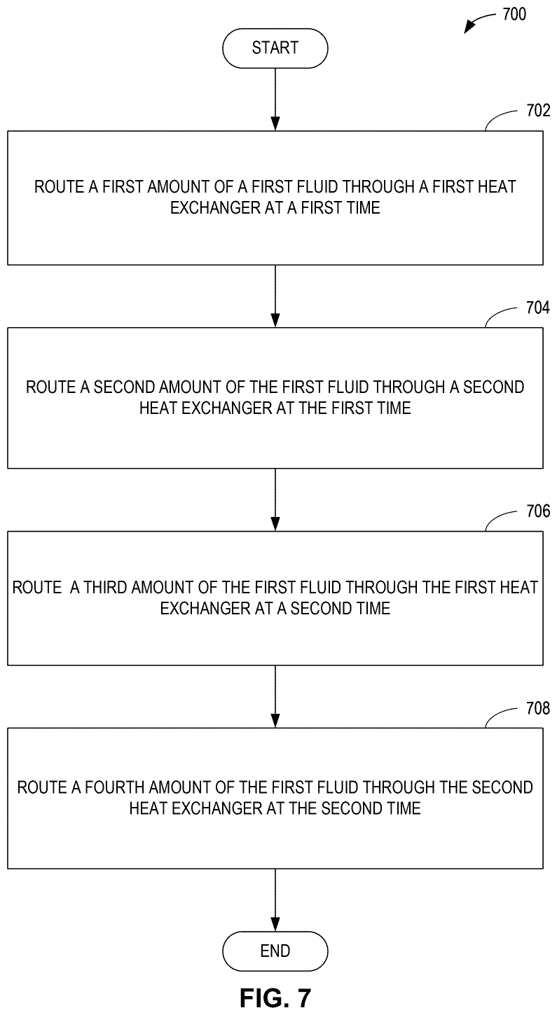

FIG. 7 is a flowchart representative of an example process 700 for passive thermal control utilizing the example thermal management systems 300, 500, 600. The example process 700 of FIG. 7 begins at block 702, at which the passive TMS 300, 500, 600 routes a first amount of a first fluid through a first heat exchanger at a first time. The first amount of the first fluid routed through the heat exchanger is passively controlled by at least one thermostatic valve. For example, the first amount of the first fluid may be controlled by the composite thermostatic valve 308, 508, 608 based on a temperature of a second fluid at the first time and/or the thermostatic bypass valve 306, 506, 606 based on a temperature of the first fluid at the first time. In some examples, the first heat exchanger is the ACOC 302, 502, 602.

At block 704, a second amount of the first fluid is routed through a second heat exchanger. The second amount of the first fluid is passively controlled by at least one thermostatic valve. For example, the second amount of the first fluid may be controlled by the composite thermostatic valve 308, 508, 608 based on the temperature of a second fluid at the first time. In some examples, the second heat exchanger is the FCOC 304, 504, 604.

At block 706, the passive TMS 300, 500, 600 routes a third amount of the first fluid through the first heat exchanger at a second time later than the first time. In some examples, the third amount of the first fluid is different than the first amount of the first fluid. For example, if the temperature of the first fluid in contact with the thermostatic element of the thermostatic valve at the second time is a different temperature than at the first time, the size of the thermostatic element changes, causing the position of the valve to change. When the valve changes position, the amount of fluid allowed to pass through the valve, and therefore through heat exchangers fluidly connected to the valve, increases or decreases.

At block 708, a fourth amount of the first fluid is routed through the second heat exchanger at the second time later than the first time. In some examples, the fourth amount of the first fluid is different than the second amount of the first fluid. For example, if the temperature of the second fluid at the second time is different than the temperature of the second fluid at the first time, the position of the valve will change, causing the second amount of fluid to increase or decrease. Then, the process 700 terminates.

From the foregoing, it will be appreciated that example systems, apparatus, articles of manufacture, and methods have been disclosed that passively control the temperature of a target fluid utilizing a plurality of heat exchangers and a plurality of thermostatic valves. As such, examples disclosed herein remove issues that may otherwise arise from requiring an active control system, such as additional costs, and space and weight requirements associated with active control systems. Additionally, examples disclosed herein increase ACOC efficiency by increasing temperature differentials between the air and the oil at the ACOC. Further, examples disclosed herein improve efficiency of a fuel-powered engine by maintaining the fuel at an optimal temperature.

Example passive thermal management systems and related methods are disclosed. Further aspects are provided by the subject matter of the following clauses:

A thermal management system includes a first heat exchanger, the first heat exchanger including a first path for a first fluid and a second path for a second fluid, the first heat exchanger to transfer thermal energy between the first fluid and the second fluid; a second heat exchanger, the second heat exchanger including a third path for the first fluid and a fourth path for a third fluid, the second heat exchanger to transfer thermal energy between the first fluid and the third fluid, the second heat exchanger in circuit with the first heat exchanger; a first thermostatic valve, the first thermostatic valve including a first thermostatic element, the first thermostatic element to actuate the first thermostatic valve to control a first rate of flow of the first fluid through the first heat exchanger based on a first temperature of the first fluid; and a second thermostatic valve, the second thermostatic valve including a second thermostatic element, the second thermostatic element to actuate the second thermostatic valve to control a second rate of flow of the first fluid through the second heat exchanger based on a second temperature of the third fluid.

The thermal management system of any preceding clause, wherein the first heat exchanger and the second heat exchanger are arranged in parallel.

The thermal management system of any preceding clause, wherein the first heat exchanger and the second heat exchanger are arranged in series.

The thermal management system of any preceding clause, wherein the first heat exchanger is an air-cooled oil cooler, the second heat exchanger is a fuel-cooled oil cooler, the first fluid is oil, the second fluid is air, and the third fluid is fuel.

The thermal management system of any preceding clause, wherein at least one of a size or a shape of the first thermostatic element changes in response to the first temperature of the first fluid at a first temperature sensing point, the first temperature sensing point downstream of the second heat exchanger.

The thermal management system of any preceding clause, wherein the first thermostatic element actuates the first thermostatic valve to a nearly closed position in response to the first temperature falling below a first low temperature threshold and the first thermostatic element actuates the first thermostatic valve to an open position in response to the first temperature exceeding a first high temperature threshold.

The thermal management system of any preceding clause, wherein at least one of a size or shape of the second thermostatic element changes in response to the second temperature of the third fluid at a second temperature sensing point, the second temperature sensing point downstream of a fuel management unit.

The thermal management system of any preceding clause, wherein the second thermostatic valve includes a first flow path and a second flow path, the second thermostatic element actuates the second thermostatic valve to nearly close the first flow path and open the second flow path in response to the second temperature falling below a second low temperature threshold, and the second thermostatic element actuates the second thermostatic valve to open the first flow path and nearly close the second flow path in response to the second temperature exceeding a second high temperature threshold.

The thermal management system of any preceding clause, wherein the first thermostatic element and the second thermostatic element are wax pellets.

A thermal management system including an air-cooled oil cooler (ACOC); a fuel-cooled oil cooler (FCOC), wherein the FCOC is in circuit with the ACOC; a first thermostatic valve, the first thermostatic valve fluidly coupled to the ACOC to control a first rate of oil flow through the ACOC based on a first temperature of oil; and a second thermostatic valve, the second thermostatic valve fluidly coupled to the FCOC to control a second rate of oil flow through the FCOC based on a second temperature of fuel.

The thermal management system of any preceding clause, wherein the ACOC and the FCOC are arranged in parallel.

The thermal management system of any preceding clause, wherein the ACOC and the FCOC are arranged in series.

The thermal management system of any preceding clause, wherein the second thermostatic valve is a composite thermostatic valve, a first oil path of the composite thermostatic valve is fluidly coupled to the ACOC, and a second oil path of the composite thermostatic valve is fluidly coupled to the FCOC.

The thermal management system of any preceding clause, wherein the second thermostatic valve includes a thermostatic element, at least one spring, and a valve body.

The thermal management system of any preceding clause, wherein the first thermostatic valve is actuated by a first thermostatic element in contact with the oil and the second thermostatic valve is actuated by a second thermostatic element in contact with the fuel.

The thermal management system of any preceding clause, wherein the second thermostatic element is in contact with the fuel upstream of a fuel management unit.

The thermal management system of any preceding clause, wherein, in response to the first temperature falling below a first low temperature threshold and the second temperature falling below a second low temperature threshold, the first thermostatic valve and the second thermostatic valve decrease the first rate of oil flow through the ACOC and increase the second rate of oil flow through the FCOC.

The thermal management system of any preceding clause, wherein, in response to the first temperature falling exceeding a first high temperature threshold and the second temperature exceeding a second high temperature threshold, the first thermostatic valve and the second thermostatic valve increase the first rate of oil flow through the ACOC and decrease the second rate of oil flow through the FCOC.

A gas turbine engine, including a compressor section, a combustion section, a turbine section, one or more components operatively coupled with at least one of the compressor section, the combustion section, or the turbine section, and the thermal management system of any preceding clause.

A method including routing a first amount of a first fluid through a first heat exchanger; and routing a second amount of the first fluid through a second heat exchanger, the first amount and second amount based on a first thermostatic valve actuated by a first thermostatic element and a second thermostatic valve actuated by a second thermostatic element.

The method of any preceding clause, wherein at least one of a first size or a first shape of the first thermostatic element changes based on a first temperature of the first fluid and at least one of a second size or a second shape of the second thermostatic element changes based on a second temperature of a second fluid.

The foregoing examples of passive TMSs can be used with aircraft engines. Although each example passive TMS disclosed above has certain features, it should be understood that it is not necessary for a particular feature of one example passive TMS to be used exclusively with that passive TMS. Instead, any of the features described above and/or depicted in the drawings can be combined with any of the passive TMSs, in addition to or in substitution for any of the other features of those passive TMSs. That is, features of one passive TMS are not mutually exclusive to features of another passive TMS. Instead, the scope of this disclosure encompasses any combination of any of the features.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A thermal management system comprising:
a first heat exchanger including a first path for a first fluid and a second path for a second fluid, the first heat exchanger to transfer thermal energy between the first fluid and the second fluid;
a second heat exchanger including a third path for the first fluid and a fourth path for a third fluid, the second heat exchanger to transfer thermal energy between the first fluid and the third fluid, the second heat exchanger in circuit with the first heat exchanger;
a first thermostatic valve including a first thermostatic element, the first thermostatic element to actuate the first thermostatic valve to control a first rate of flow of the first fluid through the first heat exchanger based on a first temperature of the first fluid; and
a second thermostatic valve including a second thermostatic element, the second thermostatic element to actuate the second thermostatic valve to control a second rate of flow of the first fluid through the second heat exchanger based on a second temperature of the third fluid.

2. The thermal management system of claim 1, wherein the first heat exchanger and the second heat exchanger are arranged in parallel.

3. The thermal management system of claim 1, wherein the first heat exchanger and the second heat exchanger are arranged in series.

4. The thermal management system of claim 1, wherein the first heat exchanger is an air-cooled oil cooler, the second heat exchanger is a fuel-cooled oil cooler, the first fluid is oil, the second fluid is air, and the third fluid is fuel.

5. The thermal management system of claim 1, wherein at least one of a size or a shape of the first thermostatic element changes in response to the first temperature of the first fluid at a first temperature sensing point, the first temperature sensing point downstream of the second heat exchanger.

6. The thermal management system of claim 1, wherein the first thermostatic element actuates the first thermostatic valve to a nearly closed position in response to the first temperature falling below a first low temperature threshold and the first thermostatic element actuates the first thermostatic valve to an open position in response to the first temperature exceeding a first high temperature threshold.

7. The thermal management system of claim 1, wherein at least one of a size or shape of the second thermostatic element changes in response to the second temperature of the third fluid at a second temperature sensing point, the second temperature sensing point downstream of a fuel management unit.

8. The thermal management system of claim 1, wherein the second thermostatic valve includes a first flow path and a second flow path, the second thermostatic element actuates the second thermostatic valve to nearly close the first flow path and open the second flow path in response to the second temperature falling below a second low temperature threshold, and the second thermostatic element actuates the second thermostatic valve to open the first flow path and nearly close the second flow path in response to the second temperature exceeding a second high temperature threshold.

9. The thermal management system of claim 1, wherein the first thermostatic element and the second thermostatic element are wax pellets.

10. A thermal management system comprising:
an air-cooled oil cooler (ACOC);
a fuel-cooled oil cooler (FCOC) in circuit with the ACOC;
a first thermostatic valve fluidly coupled to the ACOC to control a first rate of oil flow through the ACOC based on a first temperature of oil; and
a second thermostatic valve fluidly coupled to the FCOC to control a second rate of oil flow through the FCOC based on a second temperature of fuel.

11. The thermal management system of claim 10, wherein the ACOC and the FCOC are arranged in parallel.

12. The thermal management system of claim 10, wherein the ACOC and the FCOC are arranged in series.

13. The thermal management system of claim 10, wherein the second thermostatic valve is a composite thermostatic valve, a first oil path of the composite thermostatic valve is fluidly coupled to the ACOC, and a second oil path of the composite thermostatic valve is fluidly coupled to the FCOC.

14. The thermal management system of claim 13, wherein the second thermostatic valve includes a thermostatic element, at least one spring, and a valve body.

15. The thermal management system of claim 10, wherein the first thermostatic valve is actuated by a first thermostatic element in contact with the oil and the second thermostatic valve is actuated by a second thermostatic element in contact with the fuel.

16. The thermal management system of claim 15, wherein the second thermostatic element is in contact with the fuel upstream of a fuel management unit.

17. The thermal management system of claim 10, wherein, in response to the first temperature falling below a first low temperature threshold and the second temperature falling below a second low temperature threshold, the first thermostatic valve and the second thermostatic valve decrease the first rate of oil flow through the ACOC and increase the second rate of oil flow through the FCOC.

18. The thermal management system of claim 10, wherein, in response to the first temperature falling exceeding a first high temperature threshold and the second temperature exceeding a second high temperature threshold, the first thermostatic valve and the second thermostatic valve increase the first rate of oil flow through the ACOC and decrease the second rate of oil flow through the FCOC.

19. A method comprising:
routing a first amount of a first fluid through a first heat exchanger; and
routing a second amount of the first fluid through a second heat exchanger, the first amount and second amount based on a first thermostatic valve actuated by a first thermostatic element and a second thermostatic valve actuated by a second thermostatic element.

20. The method of claim 19, wherein at least one of a first size or a first shape of the first thermostatic element changes based on a first temperature of the first fluid and at least one of a second size or a second shape of the second thermostatic element changes based on a second temperature of a second fluid.
